(19) United States
(12) Patent Application Publication
(10) Pub. No.: US 2024/0110433 A1
(43) Pub. Date: Apr. 4, 2024

(54) SPACER WITH COEXTRUDED HOLLOW PROFILE

(71) Applicant: SAINT-GOBAIN GLASS FRANCE, COURBEVOIE (FR)

(72) Inventors: Florian CARRE, ÜBACH-PALENBERG (DE); Christopher MARJAN, AACHEN (DE); Erol Ertugrul SACU, STOLBERG (DE)

(21) Appl. No.: 18/262,320

(22) PCT Filed: May 11, 2022
(86) PCT No.: PCT/EP2022/062735

§ 371 Date: Jul. 20, 2023

(30) Foreign Application Priority Data
May 31, 2021 (EP) 21176940.1

(51) Int. Cl. E06B 3/663

(52) U.S. Cl. CPC E06B 3/66319

(57) ABSTRACT

A spacer for insulating glass units, includes a hollow profile extending in the longitudinal direction and coextruded from a polymeric base material and a diffusion-barrier material, including a first side wall and a second side wall, a glazing interior wall connecting the side walls to one another; an outer wall arranged substantially parallel to the glazing interior wall and connecting the side walls to one another; a cavity enclosed by the side walls, the glazing interior and outer walls. The outer wall includes at least two layers of base material and at least two layers of diffusion-barrier material, a layer of base material is always arranged between two layers of diffusion-barrier material, the layers of base material and diffusion-barrier material extend in the longitudinal direction, and at least one layer of diffusion-barrier material in the outer wall extends from the first side wall to the second side wall.

The invention relates to a spacer for insulating glass units, to an insulating glass unit and to the use thereof.

Insulating glazings generally contain at least two panes made of glass or of polymeric materials. The panes are separated from one another by a gas or vacuum space defined by the spacer. The thermal insulation capability of insulation glass is significantly higher than that of single glazing and can be even further increased and improved in triple glazings or with special coatings. For example, silver-containing coatings enable reduced transmission of infrared radiation and thus reduce the cooling of a building in winter.

In addition to the nature and structure of the glass, the further components of an insulating glazing are also of great importance. The seal and above all the spacer greatly influence the quality of the insulating glazing. In insulating glazing, a circumferential spacer is fastened between two glass panes so that a gas-filled or air-filled inner pane interspace is produced, which is sealed against the penetration of moisture and ensures the thermally insulating properties.

The thermally insulating properties of insulating glazings are substantially influenced by the thermal conductivity in the region of the edge composite, in particular of the spacer. In the case of metallic spacers, the high thermal conductivity of the metal results in the formation of a thermal bridge at the edge of the glass. On the one hand, this thermal bridge leads to heat losses in the edge region of the insulating glazing and, on the other hand, with high air humidity and low external temperatures, to the formation of condensate on the inner pane in the region of the spacer. In order to solve these problems, thermally optimized, so-called “warm-edge” systems are increasingly used, in which the spacers consist of materials of lower thermal conductivity, in particular plastics. A disadvantage of spacers made of plastics is the poor tightness in relation to gases and moisture. Plastic spacers with a barrier film made of a dense material are therefore generally provided at least on their outer side. In particular, thin metal foils or multilayer films made of metallic and polymeric layers are suitable as barrier films, as disclosed, for example, in WO 2013/104507 A1.

The connection between the pane and the spacer is produced by means of an adhesive bond made of a so-called primary sealant, e.g., polyisobutylene. If this adhesive bond fails, this will be an entry point for moisture. The amount of primary sealant must be accurately metered in order to prevent primary sealant from penetrating into the inner pane interspace. There are spacers that have, in the region of the side walls, invaginations in which primary sealant can be applied, as disclosed, for example, in US 2012 0308746 A1.

On the outward-facing side of the spacer in the outer pane interspace, a secondary sealant is generally applied as edge sealing, which absorbs mechanical load as a result of climate burdens and thus ensures the stability of the insulating glazing. The outer side of the spacer must be designed such that good adhesion to the secondary sealant is ensured. Due to temperature changes over time, for example through solar radiation, the individual components of the insulating glazing expand and contract again during cooling. The glass expands more strongly than the spacer made of a polymeric material. This mechanical movement therefore stretches or compresses the adhesive bond and the edge sealing, which can compensate for these movements only to a limited extent through their own elasticity. In the course of the service life of the insulating glazing, the mechanical stress described can mean a partial or full-area detachment of an adhesive bond. This detachment of the connection between the sealant and the spacer can permit the penetration of air moisture into the insulating glazing, which results in fogging in the region of the panes and in a decrease in the insulating effect. The sides of the spacer, which are in contact with a sealant, should therefore have the best possible adhesion to the sealant.

One approach for improving the adhesion to the sealant is the adaptation of the properties of a vapor-barrier film arranged on the outer side of the spacer. For this purpose, document EP2719533 A1 discloses a spacer with a film that has a thin adhesive layer of SiOx or AlOy on the side facing the secondary sealant. Oriented EVOH layers serve, inter glia, as the barrier layer against moisture.

A disadvantage of the concept of the spacers with barrier films is that the adhesion of the barrier films to the spacer itself and to the secondary sealant needs to be very good for a long time. Otherwise, the barrier films may detach, which in turn means loss of leak tightness. In addition, the production of these spacers with barrier films in several stages is comparatively complicated. Typically, film and base body are produced by different manufacturers and then possibly have to be glued together subsequently by a third manufacturer.

WO 2012100961 A1 describes a spacer without a separate barrier film. This spacer uses two metallic strips which are applied to the side walls and to parts of the outer wall. In the outer wall, there is a gap between the two metallic strips in order to prevent formation of a thermal bridge from the one pane to the other pane via a continuous metallic strip. In this region, sheet silicates, which ensure diffusion tightness, are introduced into the polymeric material of the outer wall. However, the metallic strips worsen the thermally insulating properties of the spacer.

Against this background, a spacer that can be produced in as few individual steps as possible and at the same time meets the requirements of a spacer for insulating glass units for leak tightness and adhesion over the service life of the insulating glass unit is desirable.

It is therefore the object of the present invention to provide an improved spacer that does not have the above-mentioned disadvantages, and to provide an improved insulating glass unit.

The object of the present invention is achieved according to the invention by a spacer for insulating glass units according to independent claim 1. Preferred embodiments of the invention emerge from the dependent claims.

An insulating glass unit according to the invention and its use emerge from further independent claims.

The spacer according to the invention for insulating glass units comprises at least one polymeric hollow profile extending in the longitudinal direction and having a first side wall, a second side wall, a glazing interior wall, an outer wall and a cavity. The cavity of the spacer leads to a reduction in weight compared to a solidly formed spacer and is available for receiving further components, such as a desiccant. The cavity is enclosed by the side walls, the glazing interior wall and the outer wall. The glazing interior wall connects the first side wall to the second side wall. The side walls are the walls of the hollow profile to which the outer panes of the insulating glass unit are attached by means of a primary sealant. The glazing interior wall is the wall of the hollow profile that faces the inner pane interspace after installation into the finished insulating glass unit. The outer wall is arranged substantially parallel to the glazing interior wall and connects the first side wall to the second side wall. After installation in the finished insulating glass unit, the outer wall faces the outer pane interspace.

The hollow profile is coextruded from a polymeric base material and a diffusion barrier material. The diffusion barrier material has a higher diffusion tightness to gases and moisture than does the polymeric base material. Since the two materials are coextruded, they are particularly firmly connected and form a long-term-stable hollow profile.

The polymeric base material and the diffusion barrier material are arranged in layers, i.e., a wall is composed of individual layers of the materials, which extend continuously, i.e., without interruption, in the longitudinal direction X and run parallel to the respective wall.

The outer wall contains at least two layers of base material and at least two layers of diffusion barrier material, which are arranged alternately. This means that a layer of base material is always arranged between two layers of diffusion barrier material. The use of a plurality of layers allows the use of diffusion barrier materials that would not achieve a sufficient barrier effect as a single layer. In addition, the barrier effect is substantially improved if a plurality of individual layers is used instead of one thick layer, because a leak at a specific location in one layer can be compensated by a second layer. In the outer wall, at least one layer of diffusion barrier material extends from the first side wall to the second side wall. The penetration of moisture and the loss of a gas filling through the layer of diffusion barrier material are thus prevented over the entire width of the hollow profile. A barrier film arranged on the outer wall is therefore no longer necessary since its function is handled by the diffusion barrier material within the hollow profile. This simplifies the production of the spacer significantly and is a great advantage of the invention.

In a preferred embodiment, layers of diffusion barrier material are arranged only in the outer wall. The side walls and the glazing interior wall do not contain a layer of diffusion barrier material in this case. This is particularly simple and cost-effective to produce.

In a further preferred embodiment, the glazing interior wall also comprises at least two layers of base material and at least two layers of diffusion barrier material. In this case, a layer of base material is always arranged between two layers of diffusion barrier material. The layers of base material and of diffusion barrier material extend in the longitudinal direction and run parallel to the glazing interior wall. The additional arrangement of diffusion barrier material in the glazing interior wall improves the sealing of the profile. Preferably, at least one layer of diffusion barrier material extends from the first side wall to the second side wall. The number of layers in the glazing interior wall and in the outer wall may differ from one another or be identical. A symmetrical structure is preferred so that the number of layers of base material and of diffusion barrier material in the glazing interior wall and in the outer wall are identical.

In a preferred embodiment, the first side wall and the second side wall consist of the base material. This is cost-effective and, as a symmetrical structure, particularly robust. An arrangement of the diffusion barrier material in the outer wall and preferably also in the glazing interior wall ensures the sealing of the spacer.

In an alternative preferred embodiment, all walls of the hollow profile comprise layers of diffusion barrier material and layers of base material. Preferably, all walls comprise the same number of layers of base material and of diffusion barrier material. This structure can be coextruded particularly well. Particularly preferably, the layers of base material and the layers of diffusion barrier material are arranged continuously around the cavity so that a layer extends from the outer wall across the first side wall across the glazing interior wall across the second side wall to the outer wall. This results in a nested onion-like structure with alternating layers of the two materials. This has proven to be particularly robust and can be coextruded very well. Particularly preferably, the layer arranged on the side facing the cavity consists of base material so that the outer layer consists of diffusion barrier material. This offers maximum protection against the penetration of moisture and against the loss of gas.

In principle, the outer layers and the layers facing the cavity can consist of diffusion barrier material or of base material. The outer layers are the layers of the spacer that face the environment, i.e., the layers that are in contact with the ambient air. For example, in the finished insulating glass unit, the outer layer of the outer wall faces the outer pane interspace and is in contact with the secondary sealant, while the outer layers of the side walls face the panes and are in contact with the primary sealant.

Preferably, the layers facing the hollow space are manufactured from the base material. These layers are not visible in the finished glazing so that materials of lower optical quality, such as recycled plastics, may also be used here. The arrangement with diffusion barrier material as an outer layer is of particular advantage because a barrier is thus arranged directly toward the external environment from where moisture can penetrate. The sealing of the spacer is thus further improved.

A wall with diffusion barrier material preferably contains three, four, five or more layers of diffusion barrier material, which are arranged alternately with an intermediate layer of base material. The diffusion tightness of the spacer can be controlled via the number of layers. With an increasing number of layers, the sealing is improved.

In a further preferred embodiment, an adhesive layer is arranged on the side of the outer wall that faces the external environment, i.e., on the side of the outer wall that faces away from the cavity, which adhesive layer has better adhesion to the secondary sealant than does the outer layer of the hollow profile.

The adhesive layer is preferably a glass film of a thickness of 0.025 mm to 0.210 mm, preferably 0.040 mm to 0.100 mm, which is glued to the outer wall. The adhesive used is preferably a non-gassing adhesive, preferably a thermoplastic polyurethane or a polymethacrylate.

Alternatively, the adhesive layer is preferably a polymer layer with one or more adhesion-promoting additives, Preferred adhesion-promoting additives are silicon oxide (SiOₓ), chromium oxide (CrOₓ), titanium oxide (TiOₓ) and/or silicon nitride (SiₓN_{y}). The content of the adhesion-promoting additive in the material of the adhesive layer is between 0.1% by weight and 20% by weight, preferably between 1% by weight and 15% by weight, particularly preferably between 2% by weight and 10% by weight. The adhesive layer preferably consists substantially of the base material of the hollow profile with added adhesion-promoting additive. This prevents material incompatibilities and stresses in the hollow profile as a result of different materials. The adhesive layer is preferably coextruded with the hollow profile. This simplifies the production process of the spacer and increases the stability of the composite. The polymer layer with adhesion-promoting additives preferably has a thickness between 50 μm and 500 μm, preferably between 100 μm and 400 μm.

Alternatively, the adhesive layer is preferably an amorphous silicon dioxide layer having a thickness of between 5 nm and 100 nm. The silicon dioxide layer is preferably deposited in a flame-pyrolytic method. The PYROSIL® method is, for example, suitable. This layer can simply be applied to the hollow profile and improves the adhesion to the secondary sealant.

In a preferred embodiment, the diffusion barrier material is a polymeric diffusion-barrier material. The advantage of a polymeric diffusion-barrier material compared to a metallic diffusion-barrier material is the lower thermal conductivity. This results in an improved insulating function of the spacer. The spacer preferably contains no metallic components, e.g., made of steel or of elemental metals. This ensures good thermal insulation. In an alternative preferred embodiment, the spacer contains metallic reinforcement elements, such as wires or sheets, which improve longitudinal stiffness.

The diffusion barrier material is preferably an ethylene vinyl alcohol copolymer (EVOH). EVOH seals the hollow profile particularly well against the penetration of moisture and the loss of a gas filling and can be coextruded with the base material. An alternative preferred diffusion-barrier material is a polyvinylidene chloride (PVDC), which is available under the trade name Saran, for example, and has excellent barrier properties.

Alternatively, the diffusion barrier material is a polymer with filler, wherein the filler is preferably a sheet silicate. The polymer is preferably the same as the base material so that material incompatibilities are avoided.

The polymer with sheet silicate has a comparatively low thermal conductivity and additionally improves the stiffness of the hollow profile. The sheet silicate is preferably admixed into the polymer in the form of small disks, which are inherently diffusion-tight. During the extrusion, the small disks are oriented to a large extent such that the flat side of the small disks is aligned parallel to the respective wall of the hollow profile. In a layer of diffusion barrier material, there are many small disks of sheet silicate, which are arranged one above the other and next to one another. The entirety of the small disks produces a barrier effect by lengthening or blocking the path for individual water molecules or gas molecules. By arranging a plurality of layers of diffusion barrier material in a wall, the barrier effect of a single layer of diffusion barrier material can be enhanced so that the use of a separate barrier film is not necessary. The content of the sheet silicate in the hollow profile is between 5% by volume and 60% by volume, preferably between 8% by volume and 35% by volume, particularly preferably between 10% by volume and 30% by volume.

Alternatively, the diffusion barrier material is a polymer with filler, wherein carbon nanotubes (CNTs) are used as the filler. The polymer is preferably the same as the base material so that material incompatibilities are avoided. The content of the carbon nanotubes in the hollow profile is preferably between 1% by volume and 20% by volume.

Thanks to the structure according to the invention, the spacer offers good sealing against the diffusion of gases, such as argon, from the pane interspace and against the diffusion of moisture into the pane interspace. The spacer according to the invention preferably meets the test standard EN 1279 Parts 2+3.

In a preferred embodiment of the spacer according to the invention, the polymeric base material contains bio-based polymers, polyethylene (PE), polycarbonates (PC), polypropylene (PP), polystyrene, polyester, polyethylene terephthalate (PET), polyethylene terephthalate glycol (PET-G), polyoxymethylene (POM), polyamides (PA), polyimide-6,6, polybutylene terephthalate (PBT), acrylonitrile butadiene styrene (ABS), acrylic ester styrene acrylonitrile (ASA), acrylonitrile butadiene styrene polycarbonate (ABS/PC), styrene acrylonitrile (SAN), PET/PC, PBT/PC, or copolymers thereof. In a particularly preferred embodiment, the polymeric base material consists essentially of one of the listed polymers. The polymeric base material particularly preferably contains recycled polymers.

The hollow profile is preferably glass-fiber-reinforced. Through the selection of the glass fiber content in the polymeric base material, the coefficient of thermal expansion of the hollow profile can be varied and adjusted. The polymeric base material preferably has a glass fiber content of 20% by weight to 50% by weight, particularly preferably 30% by weight to 40% by weight. The glass fiber content in the polymeric base material simultaneously improves the strength and stability of the hollow profile.

Glass-fiber-reinforced spacers are generally rigid spacers, which are plugged or welded together from individual straight pieces during assembly of a spacer frame for an insulating glass unit. Here, the connection points must be sealed separately with a sealant in order to ensure optimal sealing of a spacer frame.

In an alternative preferred embodiment, the hollow profile does not contain any glass fibers. The presence of glass fibers worsens the thermal insulation properties of the spacer and makes the spacer stiff and brittle. Hollow profiles without glass fibers can be bent better, wherein sealing the connection points is omitted. During bending, the spacer is exposed to particular mechanical loads.

In a further preferred embodiment, the polymeric base material consists of a foamed polymer. In this case, a foaming agent is added to the polymeric base material during the extrusion of the hollow profile. Examples of foamed spacers are disclosed in WO2016139180 A1. The foamed embodiment leads to reduced heat conduction through the hollow profile and a material- and weight-saving compared to a non-foamed hollow profile.

In a preferred embodiment of the spacer according to the invention, the hollow profile has a substantially uniform wall thickness d. The wall thickness d is preferably in the range from 0.5 mm to 2 mm. In this range, the spacer is particularly robust.

The thickness of a layer of base material is preferably between 100 μm and 900 μm, particularly preferably between 200 μm and 800 μm. The thickness of a layer of diffusion barrier material is preferably between 100 μm and 900 μm, particularly preferably between 200 μm and 800 μm.

The outer wall of the hollow profile is the wall that is opposite the glazing interior wall and faces away from the interior of the insulating glass unit (inner pane interspace) in the direction of the outer pane interspace. The outer wall preferably runs substantially parallel to the glazing interior wall. A planar outer wall, which in its entire course is parallel to the glazing interior wall, has the advantage that the sealing surface between spacer and side walls is maximized and that a simpler shaping facilitates the production process.

In a preferred embodiment of the spacer according to the invention, the portions of the outer wall that are closest to the side walls are inclined in the direction of the side walls at an angle α (alpha) of 30° to 60° to the outer wall. This embodiment improves the stability of the hollow profile. Preferably, the portions closest to the side walls are inclined at an angle α (alpha) of 45°. In this case, the stability of the spacer is further improved.

In a preferred embodiment of the spacer according to the invention, the first side wall and the second side wall run perpendicularly to the outer wall and the glazing interior wall. The first side wall and the second side wall are in this case planar side walls that run parallel to one another. This has the advantage that a planar surface is available for bonding to the outer panes of the insulating glazing.

In a further preferred embodiment of the spacer according to the invention, the first side wall and the second side wall are curved in the direction of the cavity. In this way, a first recess in the first side wall is in each case formed for receiving a primary sealant arranged between the first side wall and the adjacent pane. A second recess in the second side wall is produced for receiving a primary sealant arranged between the second side wall and the adjacent pane. The application of the primary sealant in the recesses improves the sealing and prevents primary sealant from penetrating in the direction of the inner pane interspace. This effect can occur in particular at high temperatures, such as under solar radiation. The two side walls are preferably curved to the same extent in the direction of the cavity so that the first recess and the second recess are of the same size and the spacer has a symmetrical structure. This improves the stability of the hollow profile.

In a preferred embodiment, an opaque decorative layer is arranged on the side of the glazing interior wall that faces away from the cavity. The decorative layer is then the visible surface in the finished insulating glass unit so that it can be designed in a visually appealing manner. For example, the color of the glazing interior wall can be flexibly adapted or a visually less attractive recycled polymer can be used as the base material because only the opaque decorative layer is visible to the user. In this context, opaque means that the decorative layer hides the underlying layer from the view of the user. The decorative layer is thus not translucent or transparent but opaque. The decorative layer is preferably a polymeric decorative layer. Alternatively, it may also consist of, for example, wood, paper, polymers, a sprayed-on paint layer or glass. The decorative layer can be glued as a film to the hollow profile, sprayed, applied or preferably coextruded as a polymeric decorative layer with the polymeric base material and the diffusion barrier material.

In a preferred embodiment, the glazing interior wall has at least one perforation. Preferably, a plurality of perforations are formed in the glazing interior wall. The total number of perforations depends on the size of the insulating glass unit. The perforations in the glazing interior wall connect the hollow space to the inner pane interspace of an insulating glass unit, thereby enabling a gas exchange between them. This allows absorption of air moisture by a desiccant located in the cavity and thus prevents the panes from fogging. The perforations are preferably designed as slots, particularly preferably as slots of a width of 0.2 mm and a length of 2 mm. The slots ensure optimal air exchange without desiccant being able to penetrate from the cavity into the inner pane interspace. After production of the hollow profile, the perforations can simply be punched or drilled into the glazing interior wall. The perforations are preferably punched hot into the glazing interior wall.

The hollow profile preferably has a width of 5 mm to 55 mm, preferably of 10 mm to 20 mm, along the glazing interior wall. In the sense of the invention, the width is the dimension extending between the side walls. The width is the distance between the surfaces of the two side walls that face away from one another. The distance between the panes of the insulating glass unit is determined through the selection of the width of the glazing interior wall. The exact dimensions of the glazing interior wall depend on the dimensions of the insulating glass unit and the desired pane interspace size.

The hollow profile preferably has a height of 5 mm to 15 mm, particularly preferably of 6 mm to 10 mm, along the side walls. In this height range, the spacer has an advantageous stability but is otherwise advantageously inconspicuous in the insulating glass unit. In addition, the cavity of the spacer has an advantageous size for receiving an appropriate quantity of desiccant. The height of the spacer is the distance between the surfaces of the outer wall and of the glazing interior wall that face away from one another.

The cavity preferably contains a desiccant, preferably silica gels, molecular sieves, CaCl₂, Na₂SO₄, activated carbon, silicates, bentonites, zeolites, and/or mixtures thereof.

The invention also comprises a method for producing a spacer according to the invention, at least comprising the step of coextruding the polymeric base material and the diffusion barrier material to form the hollow profile.

The invention furthermore comprises an insulating glass unit with at least a first pane, a second pane, a circumferential spacer according to the invention arranged between the first and second panes, an inner pane interspace and an outer pane interspace. The spacer according to the invention is arranged to form a circumferential spacer frame. The first pane is attached to the first side wall of the spacer by means of a primary sealant, and the second pane is attached to the second side wall by means of a primary sealant. This means that a primary sealant is arranged between the first side wall and the first pane and between the second side wall and the second pane. The first pane and the second pane are arranged parallel and preferably congruently. The edges of the two panes are therefore preferably arranged flush in the edge region, i.e., they are located at the same height. The inner pane interspace is delimited by the first and second panes and the glazing interior wall. The outer pane interspace is defined as the space that is delimited by the first pane, the second pane and the outer wall of the spacer. The outer pane interspace is at least partially filled with a secondary sealant. The secondary sealant contributes to the mechanical stability of the insulating glass unit and absorbs a portion of the climate burdens that act on the edge composite.

In a preferred embodiment, an adhesive layer is arranged on the side of the outer wall that faces the outer pane interspace, and the secondary sealant is in contact with the adhesive layer. The adhesive layer has particularly good adhesion to the secondary sealant. This improves the sealing and long-term stability of the edge composite of the insulating glass unit.

In a preferred embodiment, the first side wall and the second side wall are curved in the direction of the cavity of the spacer so that a first recess is filled with the primary sealant between the first side wall and the first pane and so that a second recess is filled with the primary sealant between the second side wall and the second pane. The recesses provide the possibility of introducing more primary sealant than in the case of a completely planar side wall. This improves the stability of the seal along the side walls. In addition, the primary sealant is prevented in the event of strong solar radiation from flowing into the inner pane interspace and becoming visible there.

In a further preferred embodiment of the insulating glass unit according to the invention, the secondary sealant is applied along the first pane and the second pane such that a central region of the outer wall is free of secondary sealant. The central region denotes the region arranged centrally in relation to the two outer panes, in contrast to the two outer regions of the outer wall, which are adjacent to the first pane and the second pane. In this way, good stabilization of the insulating glass unit is achieved, wherein material costs for the secondary sealant are saved at the same time. At the same time, this arrangement can be easily produced by applying two strands of secondary sealant to the outer wall in the outer region adjacently to the outer panes.

In a further preferred embodiment, the secondary sealant is applied such that the entire outer pane interspace is completely filled with secondary sealant. This leads to maximum stabilization of the insulating glass unit.

The secondary sealant preferably contains polymers or silane-modified polymers, particularly preferably organic polysulfides, silicones, hot melt, polyurethanes, room-temperature crosslinking (RTV) silicone rubber, peroxide-crosslinked silicone rubber and/or addition-crosslinked silicone rubber. These sealants have a particularly good stabilizing effect.

The primary sealant preferably contains a polyisobutylene. The polyisobutylene may be a crosslinking or non-crosslinking polyisobutylene.

The first pane and the second pane of the insulating glass unit preferably contain glass, ceramic and/or polymers, particularly preferably quartz glass, borosilicate glass, soda-lime glass, polymethyl methacrylate or polycarbonate.

The first pane and the second pane have a thickness of 2 mm to 50 mm, preferably 3 mm to 16 mm, wherein the two panes may also have different thicknesses.

In a preferred embodiment of the insulating glass unit according to the invention, the spacer frame consists of one or more spacers according to the invention. For example, it may be a spacer according to the invention which is bent to form a complete frame. It may also be a plurality of spacers according to the invention which are linked to one another via one or more plug connectors. The plug connectors may be designed as longitudinal connectors or corner connectors. Such corner connectors may be designed, for example, as a plastic molded part with a seal, in which two spacers provided with a miter cut abut.

In principle, a wide variety of geometries of the insulating glass unit are possible, e.g., rectangular, trapezoidal and rounded shapes. In order to produce round geometries, the spacer according to the invention may, for example, be bent in the heated state.

In a further embodiment, the insulating glazing comprises more than two panes. In this case, the spacer can contain, for example, grooves in which at least one further pane is arranged. A plurality of panes could also be formed as a laminated glass pane.

The invention furthermore comprises a method for producing an insulating glass unit according to the invention, at least comprising the steps of:
providing a spacer according to the invention,
joining the spacer to form a spacer frame,
providing a first pane and a second pane,
fastening the spacer by means of a primary sealant between the first pane and the second pane,
compressing the pane arrangement of the two panes and the spacer, and
at least partially filling the outer pane interspace with a secondary sealant.

The insulating glass unit is produced automatically in double-glazing systems known to the person skilled in the art. First, a spacer frame comprising the spacer according to the invention is provided. For example, the spacer frame is produced by welding, gluing and/or by means of a plug connector. A first pane and a second pane are provided and the spacer frame is fixed between the first and the second pane by means of a primary sealant. The spacer frame is placed with the first side wall of the spacer onto the first pane and fastened by means of the primary sealant. The second pane is then placed congruently with the first pane onto the second side wall of the spacer and likewise fastened by means of the primary sealant, and the pane arrangement is compressed. The outer pane interspace is at least partially filled with a secondary sealant. The method according to the invention thus enables the simple and cost-effective production of an insulating glass unit.

The first pane and the second pane may also be provided before the spacer frame according to the invention is provided.

The invention furthermore comprises the use of the insulating glass unit according to the invention as building interior glazing, building exterior glazing and/or façade glazing.

The various embodiments of the invention may be implemented individually or in any combinations. In particular, the features mentioned above and explained below can be used not only in the specified combinations but also in other combinations or alone without departing from the scope of the present invention.

The statements regarding the spacer according to the invention apply analogously to the insulating glass unit according to the invention and to the method according to the invention. Likewise, the statements regarding the insulating glass unit according to the invention can also be applied to the spacer according to the invention.

The invention is explained in more detail below with reference to drawings. The drawings are purely schematic representations and are not true to scale. They do not restrict the invention in any way. Shown are:

FIG. 1 a cross-section of a further possible embodiment of a spacer according to the invention,

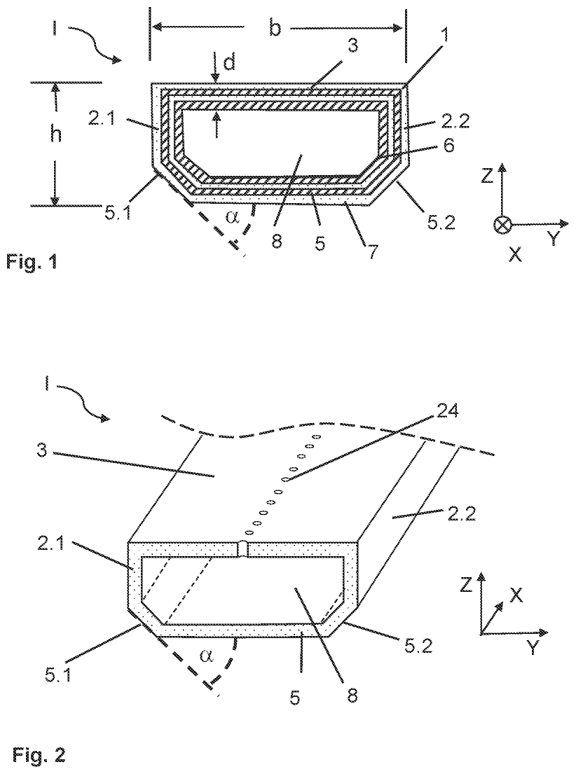

FIG. 2 a detail of a hollow profile,

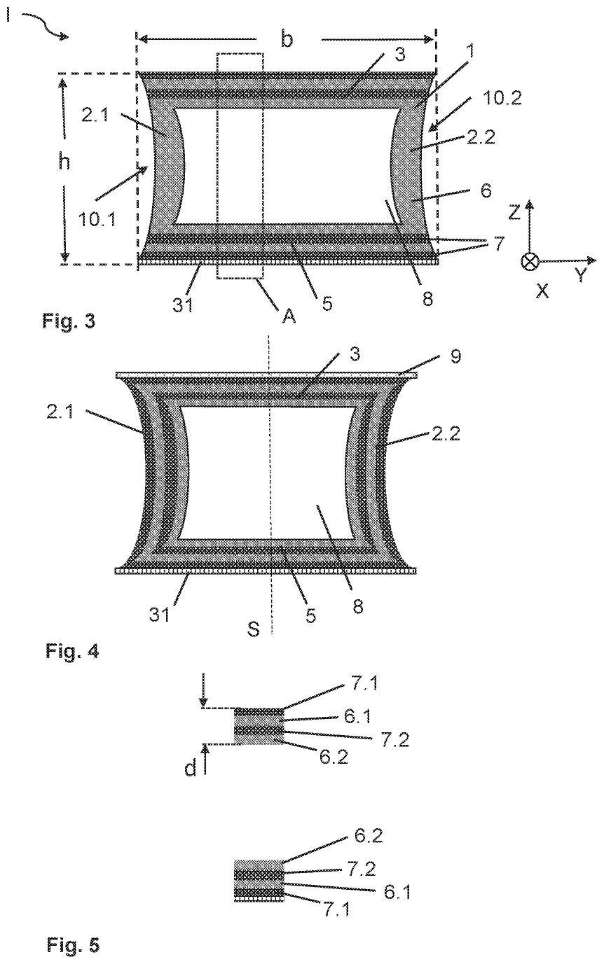

FIG. 3 a cross-section of a possible embodiment of a spacer according to the invention,

FIG. 4 a cross-section of a further possible embodiment of a spacer according to the invention,

FIG. 5 a cross-section of the detail A of FIG. 3,

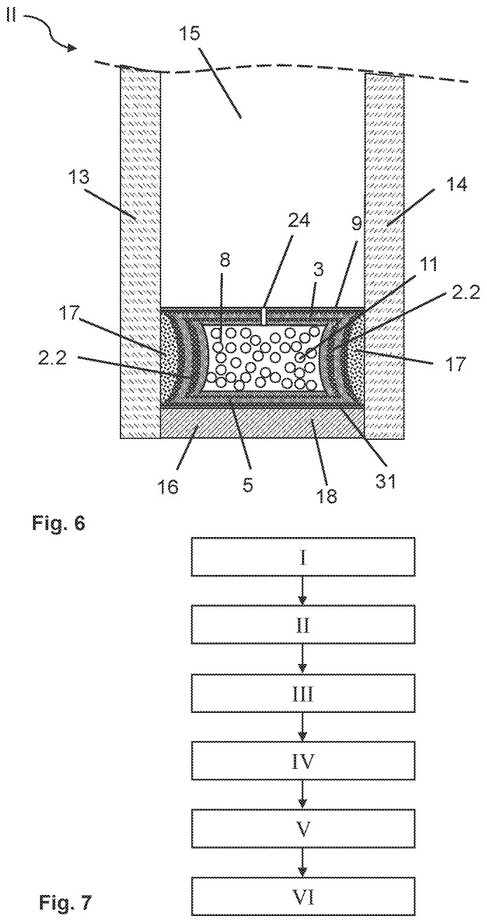

FIG. 6 a cross-section of a possible embodiment of an insulating glass unit according to the invention,

FIG. 7 a flow chart for producing an insulating glass unit according to the invention.

FIG. 1 shows a cross-section through a possible spacer I according to the invention. FIG. 2 shows a perspective cross-section of the spacer with a plan view of the glazing interior wall 3, wherein FIG. 2 does not show the layer-like structure of the hollow profile 1. The spacer comprises a coextruded hollow profile 1 extending in the longitudinal direction (X) and having a first side wall 2.1, a side wall 2.2 running parallel thereto, a glazing interior wall 3 and an outer wall 5. The glazing interior wall 3 runs perpendicularly to the side walls 2.1 and 2.2 and connects the two side walls. The outer wall 5 is opposite the glazing interior wall 3 and connects the two side walls 2.1 and 2.2. The outer wall 5 runs substantially perpendicularly to the side walls 2.1 and 2.2. The portions 5.1 and 5.2 of the outer wall 5 that are closest to the side walls 2.1 and 2.2 are however inclined in the direction of the side walls 2.1 and 2.2 at an angle α (alpha) of about 45° to the outer wall 5. The angled geometry improves the stability of the hollow profile 1.

The hollow profile 1 is a coextruded hollow profile which is coextruded from a plurality of layers of a polymeric base material 6 and a diffusion barrier material 7. For example, polypropylene with 10% by weight of glass fibers was used as the base material 6 and EVOH was used as the diffusion barrier material 7. The polymeric base material 6 and the diffusion barrier material 7 are arranged in layers. In all walls 3, 2.1, 2.2 and 5, the individual layers of the materials are arranged continuously, i.e., without interruption, in the longitudinal direction X and run parallel to the respective wall. The arrangement of the diffusion barrier material in all walls of the hollow profile 1 ensures particularly good sealing of the spacer against the penetration of moisture. In all walls, the hollow profile 1 in each case contains two layers of base material 6 and two layers of diffusion barrier material 7. EVOH, which would not have a sufficient barrier effect as a single layer, may thus be used so that a completely metal-free spacer is obtained in the example. This ensures particularly low heat conduction through the spacer. The layers of base material 6 and of diffusion barrier material 7 are in each case arranged alternately so that an onion-like structure is produced. As seen from the side facing the cavity 8, the sequence of the layers is: base material-diffusion-barrier material-base material-diffusion-barrier material. The cavity 8 is thus completely delimited by the base material 6 and, on the side of the spacer I that faces the external environment, diffusion-barrier material 7 is arranged everywhere. Since the outer layer consists of diffusion-barrier material 7, maximum protection against the penetration of moisture and against gas loss from the inner pane interspace is ensured.

The wall thickness d of the hollow profile is 1 mm. The wall thickness is substantially the same everywhere. This improves the stability of the hollow profile and simplifies production. The hollow profile 1 has, for example, a height h of 6.5 mm and a width of 15.5 mm. The width extends in the Y direction from the first side wall 2.1 to the second side wall 2.2. The outer wall 5, the glazing interior wall 3 and the two side walls 2.1 and 2.2 enclose the cavity 8. The cavity 8 can receive a desiccant 11. Perforations 24, which produce a connection to the inner pane interspace in the insulating glass unit, are formed in the glazing interior wall 3. The desiccant 11 can then absorb moisture from the inner pane interspace 15 via the perforations 24 in the glazing interior wall 3. No additional barrier film is arranged on the outer wall 5 since the layers of EVOH completely assume the barrier function. The layers of base material 6 each have a thickness of 300 μm and the layers of diffusion-barrier material 7 each have a thickness of approximately 200 μm (in the drawing, the layer thicknesses are outlined with approximately the same thickness for illustrative purposes).

FIG. 3 shows a cross-section through a possible spacer I according to the invention. FIG. 5 shows the detail A from FIG. 3 for a detailed view of the layer structure in the glazing interior wall 3 and the outer wall 5. The spacer I comprises a coextruded hollow profile 1 extending in the longitudinal direction (X) and having a first side wall 2.1, a second side wall 2.2, a glazing interior wall 3 and an outer wall 5 extending parallel thereto. The glazing interior wall 3 connects the two side walls 2.1 and 2.2. The outer wall 5 is opposite the glazing interior wall 3 and connects the two side walls 2.1 and 2.2. The first side wall 2.1 and the second side wall 2.2 are curved in the direction of the cavity 8 so that a first recess 10.1 for the primary sealant is provided between the first side wall 2.1 and the first pane, and a second recess 10.2 for the primary sealant is provided between the second side wall 2.2 and the second pane. The recesses provide the possibility of introducing more primary sealant than in the case of a completely planar side wall. This improves the stability of the seal along the side walls. In addition, the primary sealant is prevented in the event of strong solar radiation from flowing into the inner pane interspace and becoming visible there. The two side walls 2.1 and 2.2 are curved to the same extent in the direction of the cavity 8 so that the recesses 10.1 and 10.2 are of the same size and the spacer has a symmetrical structure. The symmetry in this case is in relation to the axis of symmetry S, as shown in FIG. 4.

The hollow profile 1 is a coextruded hollow profile which is coextruded from a polymeric base material 6 and a diffusion barrier material 7. The first side wall 2.1 and the second side wall 2.2 consist of the base material 6. This is cost-effective and, as a symmetrical structure, particularly stable. Two layers of the diffusion barrier material and two layers of the polymeric base material are in each case arranged alternately in the outer wall 5 and in the glazing interior wall 3, The layers of the diffusion barrier material in the outer wall 5 and in the glazing interior wall 3 extend over the entire width b of the hollow profile and thus ensure good sealing of the spacer. The individual layers of the materials in the glazing interior wall 3 and the outer wall 5 are arranged continuously, i.e., without interruption, in the longitudinal direction X and run parallel to the respective wall. The base material 6 used was, for example, polyamide 6.6, and polyamide 6.6 with 25% by volume of sheet silicate was used as the diffusion barrier material 7. A completely metal-free spacer is thus obtained. This ensures particularly low heat conduction through the spacer. The inner layer 6.2 of the outer wall and of the glazing interior wall 3 each consist of polymeric base material. The cavity 8 is thus completely delimited by the base material 6, and diffusion-barrier material 7 is arranged on the side of the hollow profile I that faces the outer pane interspace. Since the outer layer 7.1 consists of diffusion-barrier material 7, maximum protection against the penetration of moisture and against gas loss from the inner pane interspace is ensured.

An adhesive layer 31 is arranged on the outer wall 5 on the side facing the external environment. The adhesive layer 31 is in contact with the secondary sealant in the finished insulating glass unit. In the example, the adhesive layer 31 is coextruded with the hollow profile 1 and consists substantially of PE with 10% by weight of SiOx as the adhesion-promoting additive. The adhesive layer 31 has a better adhesion to the secondary sealant so that the long-term stability of the edge composite is further improved thanks to the structure according to the invention. The thickness of the adhesive layer 31 in the example is approximately 100 μm.

The wall thickness d of the hollow profile is approximately 1 mm. The wall thickness is essentially the same everywhere. This improves the stability of the hollow profile and simplifies production. The hollow profile 1 has, for example, a height h of 6.5 mm and a width b of 12.5 mm. The width extends in the Y direction from the first side wall 2.1 to the second side wall 2.2, measured at the widest point of the hollow profile along the glazing interior wall 3 or the outer wall 5. The widths b at the heights of the glazing interior wall 3 and of the outer wall 5 are the same. The outer wall 5, the glazing interior wall 3 and the two side walls 2.1 and 2.2 enclose the cavity 8. The cavity 8 can receive a desiccant 11. Perforations (not shown here), which produce a connection to the inner pane interspace in the insulating glass unit, are formed in the glazing interior wall 3. The desiccant 11 can then absorb moisture from the inner pane interspace 15 via the perforations in the glazing interior wall 3. No additional barrier film is arranged on the outer wall 5 since the layers of sheet silicate completely assume the barrier function. The layers of base material 6 each have a thickness of 250 μm and the layers of diffusion-barrier material 7 each have a thickness of approximately 250 μm.

FIG. 4 shows a spacer which is basically constructed like the spacer shown in FIG. 3. In contrast to the spacer shown in FIG. 3, all walls 3, 2.1, 2.2 and 5 of the hollow profile 1 in the example comprise two layers of diffusion barrier material 7 and two layers of base material 6. This structure with the same number of layers in all walls can be coextruded particularly well. The layers of base material 6 and the layers of diffusion-barrier material 7 are arranged continuously around the cavity 8 so that each layer extends from the outer wall 5 across the first side wall 2.1 across the glazing interior wall 3 across the second side wall 2.2 to the outer wall 5. This results in a nested onion-like structure with alternating layers of the two materials. This has proven to be particularly stable and can be coextruded very well. The inner layer arranged on the side facing the cavity consists in the example of the base material 6 so that the outer layer consists of diffusion-barrier material 7. This offers maximum protection against the penetration of moisture and against the loss of gas. The layers of diffusion-barrier material 7 have a thickness of 200 μm each and the layers of the polymeric base material have a thickness of 300 μm. An opaque decorative layer 9 in the form of a black PET film, which hides the underlying hollow profile 1 from view, is glued to the side of the glazing interior wall 3 that faces the glazing interior. This is particularly advantageous if the base material 6 in the example is a recycled polypropylene and the diffusion-barrier material 7 is an EVOH. The recycled polypropylene is then effectively covered and a visually pleasing image is produced for the user of the insulating glass unit. In order to improve the adhesion to the secondary sealant, an adhesive layer 31 in the form of a silicon dioxide layer of approximately 30 nm thickness is arranged on the outer wall 5 and is applied in the example by means of PYROSIL®-V.

FIG. 6 shows a cross-section of the edge region of an insulating glass unit II according to the invention with the spacer I shown in FIG. 4. The first pane 13 is connected to the first side wall 2.1 of the spacer I by means of a primary sealant 17, and the second pane 14 is attached to the second side wall 2.2 by means of the primary sealant 17. The primary sealant 17 is essentially a crosslinking polyisobutylene. The inner pane interspace 15 is located between the first pane 13 and the second pane 14 and is delimited by the glazing interior wall 3 of the spacer I according to the invention. The inner pane interspace 15 is air-filled or filled with an inert gas, such as argon. The cavity 8 is filled with a desiccant 11, for example a molecular sieve. The cavity 8 is connected to the inner pane interspace 15 via perforations 24 in the glazing interior wall 3. Through the perforations 24 in the glazing interior wall 3, a gas exchange takes place between the cavity 8 and the inner pane interspace 15, wherein the desiccant 11 absorbs the air moisture from the inner pane interspace 15. The first pane 13 and the second pane 14 project beyond the side walls 2.1 and 2.2 so that an outer pane interspace 16 is produced, which is located between the first pane 13 and the second pane 14 and is delimited by the outer wall 5 with the adhesive layer 31 of the spacer I. The edge of the first pane 13 and the edge of the second pane 14 are arranged at the same height. The outer pane interspace 16 is filled with a secondary sealant 18. The secondary sealant 18 in the example is a polysulfide. Polysulfides absorb the forces acting on the edge composite particularly well and thus contribute to high stability of the insulating glass unit II. The adhesion of polysulfides to the adhesive layer of the spacer according to the invention is excellent. The first pane 13 and the second pane 14 consist of soda-lime glass of a thickness of 3 mm.

FIG. 7 shows the flow chart of a method according to the invention for producing an insulating glass unit II according to the invention. In a first step I, a spacer I according to the invention is provided. In a second step II, the spacer I is joined together to form a spacer frame. In a third step III, a first pane 13 and a second pane 14 are provided. Alternatively, the third step III may also take place before the first step I. In a fourth step IV, the spacer I is fastened between the first pane 13 and the second pane 14 by means of a primary sealant 17, In a fifth step V, the pane arrangement of the panes 13, 14 and the spacer I is compressed in an insulation glass press. In a sixth step VI, the outer pane interspace 16 is at least partially filled with a secondary sealant 18.

### LIST OF REFERENCE SIGNS

I Spacer
II Insulating glass unit, insulating glazing
1 Hollow profile
2.1 First side wall
2.2 Second side wall
3 Glazing interior wall
5 Outer wall
5.1, 5.2 The portions of the outer wall that are closest to the side walls
6 Base material, polymeric base material
6.1, 6.2 First and second layers of base material
7 Diffusion-barrier material
7.1, 7.2 First and second layers of diffusion-barrier material
8 Cavity
9 Decorative layer
10 Recess, cutout
10.1, 10.2 First or second recess
11 Desiccant
13 First pane
14 Second pane
15 Inner pane interspace
16 Outer pane interspace
17 Primary sealant
18 Secondary sealant
24 Perforation in the glazing interior wall
31 Adhesive layer
X Longitudinal direction, extension direction of the hollow profile
Y Transverse direction
Z Height direction
d Wall thickness
h Height of the base body
b Width of the base body

1. A spacer for insulating glass units, comprising:
a hollow profile extending in a longitudinal direction and coextruded from a polymeric base material and a diffusion barrier-material, comprising
a first side wall and a second side wall, a glazing interior wall connecting the first and second side walls to one another;
an outer wall arranged substantially parallel to the glazing interior wall and connecting the first and second side walls to one another;
a cavity enclosed by the first and second side walls, the glazing interior wall and the outer wall,
wherein
the outer wall comprises at least two layers of base material and at least two layers of diffusion-barrier material,
a layer of base material is always arranged between two layers of diffusion-barrier material,
the layers of base material and diffusion-barrier material extend in the longitudinal direction, and
at least one layer of diffusion-barrier material in the outer wall extends from the first side wall to the second side wall.

2. The spacer for insulating glass units according to claim 1, wherein
the glazing interior wall comprises at least two layers of base material and at least two layers of diffusion-barrier material,
a layer of base material is always arranged between two layers of diffusion-barrier material, and
the layers of base material and diffusion-barrier material extend in the longitudinal direction.

3. The spacer for insulating glass units according to claim 1, wherein the first side wall, the second side wall and the glazing interior wall comprise the same number of layers of base material and of diffusion-barrier material as the outer wall.

4. The spacer for insulating glass units according to claim 1, wherein the first side wall and the second side wall consist of the base material.

5. The spacer for insulating glass units according to claim 1, wherein the first side wall and the second side wall are curved in a direction of the cavity.

6. The spacer for insulating glass units according to claim 1, wherein an adhesive layer is arranged on a side of the outer wall that faces away from the cavity.

7. The spacer for insulating glass units according to claim 6, wherein the adhesive layer is a glass film fastened to the outer wall by an adhesive.

8. The spacer for insulating glass units according to claim 6, wherein the adhesive layer is coextruded with the hollow profile and the adhesive layer is a polymer layer with one or more adhesion-promoting additives, wherein the adhesion-promoting additives are selected from the group of silicon oxide, chromium oxide, titanium oxide and/or silicon nitride.

9. The spacer for insulating glass units according to claim 1, wherein the polymeric base material comprises bio-based polymers, polyethylene (PE), polycarbonates (PC), polypropylene (PP), polystyrene, polyester, polyethylene terephthalate (PET), polyethylene terephthalate glycol (PET-G), polyoxymethylene (POM), polyamides, polyamide-6,6, polybutylene terephthalate (PBT), acrylonitrile butadiene styrene (ABS), acrylic ester styrene acrylonitrile (ASA), acrylonitrile butadiene styrene polycarbonate (ABS/PC), styrene acrylonitrile (SAN), PET/PC, PBT/PC, or copolymers thereof.

10. The spacer for insulating glass units according to claim 1, wherein the cavity is delimited completely by the base material.

11. The spacer for insulating glass units according to claim 1, wherein an opaque decorative layer is arranged on a side of the glazing interior wall that faces away from the cavity.

12. An insulating glass unit, comprising a first pane, a second pane, a spacer according to claim 1 arranged circumferentially between the first pane and the second pane, wherein
the first pane is attached to the first side wall by a primary sealant,
the second pane is attached to the second side wall by a primary sealant,
an inner pane interspace is delimited by the glazing interior wall, the first pane and the second pane,
an outer pane interspace is delimited by the outer wall and the first pane and the second pane, and
a secondary sealant is arranged in the outer pane interspace.

13. The insulating glass unit according to claim 12, wherein an adhesive layer is arranged on a side of the outer wall that faces the outer pane interspace, and the secondary sealant is in contact with the adhesive layer.

14. The insulating glass unit according to claim 12, wherein the first side wall and the second side wall are curved in the direction of the cavity so that a first recess is filled with the primary sealant between the first side wall and the first pane and so that a second recess is filled with the primary sealant between the second side wall and the second pane.

15. A method comprising providing an insulating glass unit according to claim 12 as building interior glazing, building exterior glazing and/or façade glazing.
